(19) United States
(12) Patent Application Publication
(10) Pub. No.: US 2007/0128001 A1
(43) Pub. Date: Jun. 7, 2007

(54) Screw with two types of threads

(76) Inventor: Guo-Cai Su, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/295,588

(22) Filed: Dec. 7, 2005

(51) Int. Cl. F16B 35/04

(52) U.S. Cl. 411/413

(57) ABSTRACT

A screw includes two types of threads which the first threads located close to the point of the shank and the second threads extend from the head of the screw, the two threads spiral in opposite direction. Said first threads have the outside diameter larger than the outside diameter of the second threads having a greater flank angle than the first threads so that the first threads can easily cut the fibers of the object and quickly merge into the object and the debris of fibers is heaped on the second threads which firmly fasten the screw in the object.

### BACKGROUND OF THE INVENTION

1. Field of the Invention

The present invention relates to a screw with two types of threads, particularly to penetrate and secure a work piece.

2. Description of the Related Art

A conventional screw is disclosed by U.S. Pat. No. 6,666,638 in FIG. 1 and generally includes a head 11 and a shank 12 connected to the head 11 which has threads 13 defined on an outside surface thereof. Said threads 13 have a first threaded section 131 which includes a point of the shank 121 and a second threaded section 132 which located between the head 11 and the first threaded section 131. The first threaded section 131 has right-hand threads and the second threaded section 132 has left-hand threads; the two sections are separated by a transition section 14. The right-hand threads on the first threaded section 131 have outside diameter smaller than the left-handed threads on the second threaded section 132; said right-hand threads have the flank angle α and pitch P1 greater than the flank angle β and pitch P2 of the left-hand threads on the second threaded section. In use of the conventional screw, the dull angle of the right-hand threads on the first threaded section are used to cut the fibers of object which results of low screwing speed.

The present invention intends to provide a screw that includes two types of threads and the threads closing to the point rapidly cut the fibers of object and threads closing to the head squeeze the debris of fiber back to the remnant-producing material to firmly fasten the screw in the object.

### SUMMARY OF THE INVENTION

The present invention relates to a screw which comprises a head, a shank connected to the head and a plurality of threads defined on the shank. Said threads have two threaded section, the first threaded section with the first threads and the second threaded section with the second threads; said two threads spiral in opposite direction. The first threads have the outside diameter larger than the outside diameter of second threads and Said first threads have having smaller flank angle than the second threads.

The present invention will become more obvious from the following description when taken in connection with the accompanying drawings which show, for purposes of illustration only, a preferred embodiment in accordance with the present invention.

### BRIEF DESCRIPTION OF THE DRAWINGS

The accompanying drawing is to provide a further understanding of the invention and to incorporate in and constitute a part of this specification. The drawing illustrates an embodiment of the invention, and together with the description, serves to explain the principles of the invention. In the drawing,

FIG. 1 shows the U.S. Pat. No. 6,666,638 screw;

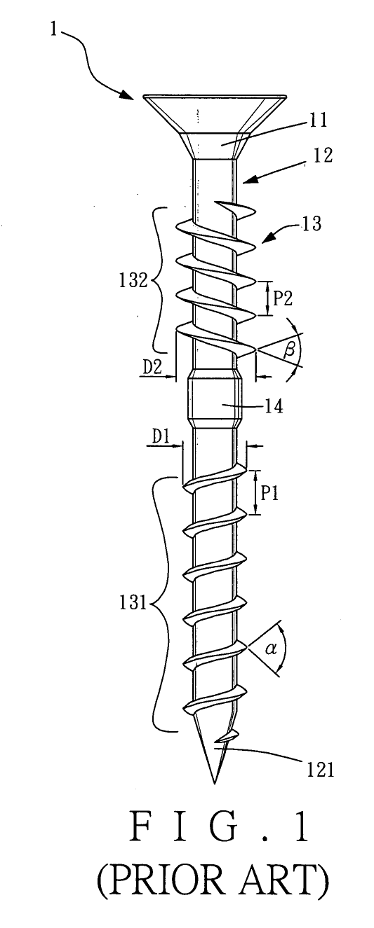

FIG. 2 shows the U.S. Pat. No. 6,666,638 screw penetrates into an object;

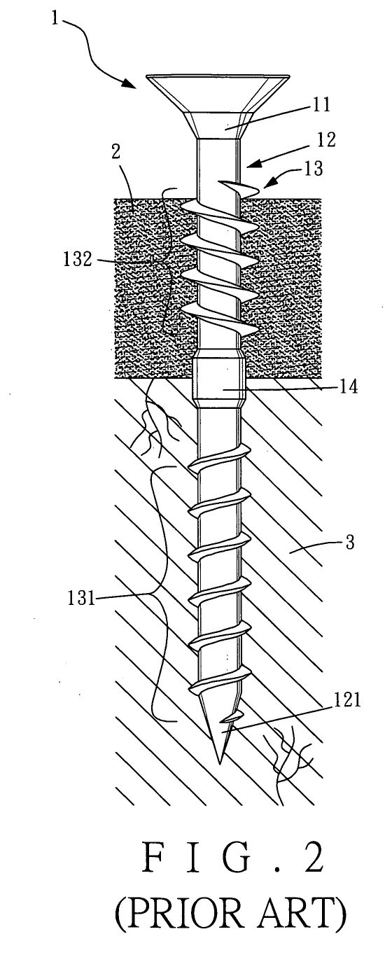

FIG. 3 shows a screw of present invention, and

FIG. 4 shows a preferring embodiment of the screw penetrates into an object.

### DETAILED DESCRIPTION OF THE PREFERRED EMBODIMENTS

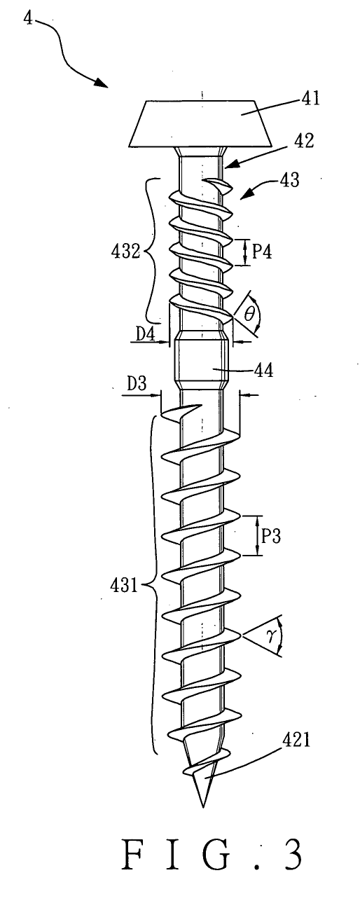

Referring to FIGS. 3 the screw 4 of the present invention comprises a head 41 and a shank 42 connected to the head 41. A plurality of threads 43 are spirally connected to the shank 42. Said threads 43 further separated to the first threaded section 431 closing to the point of shank 421 and the second threaded section 432 located between the head 41 and the first threaded section 431, two of which are divided by a transition section 44. Said transition section 44 has no threads. The first threaded section 431 has right-hand thread and the second threaded section 432 has left-hand threads. The outside diameter of the right-hand threads D3 is greater than the outside diameter of the left-hand threads D4. Said right-hand threads have a flank angleγ which is smaller than the flange angle of the left-hand threads θ forming a sharper cutting edge on the right-hand threads. Thus, said right-hand threads have a first pitch P3 and said left-hand threads have a second pitch P4, wherein said first pitch P3 is greater than said second pitch P4.

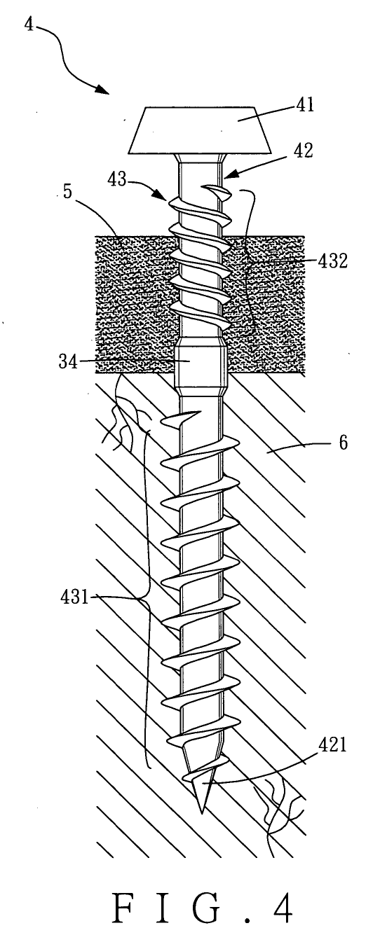

Refer now to FIG. 4 the screw 4 penetrates through the remnant-producing material by using the shaper cutting edges on the right-hand threads to cut the fibers of remnant-producing material 5 and inserts in the wood material which combines the remnant-producing material 5 and wood material 6 together. Said right-hand threads have greater outside diameter D3 which aid in fixing the first threaded section 431 in the wood material 6 and said left-hand threads have smaller outside diameter D4 which reduce the friction of the second threaded section 432 and the remnant-producing material 5 when screwing. Thus the left-hand threads squeeze back debris of the fibers of remnant-producing material 5 and wood material 6 generated by the right-hand threads to fix the second threaded section 432 on the remnant-producing material 5. With the means of the transition section 44, the remnant-producing material 5 and wood material 6 are firmly bonded with each other.

As indicated above, the invention has the following advantages:

1. Rapidly Screw:

Because of the sharp angle on the right-hand threads of the first threaded section, the threads cut the fibers of object and screw in rapidly

2. Firmly Screw:

Because of the greater outside diameter of the right-hand threads, the first threaded section firmly fixes in wood material after inserting and simultaneously the left-handed threads squeeze back the debris of fibers of object to fix the second threaded section in the remnant-producing material.

While we have shown and described the embodiment in accordance the present invention, it should be clear to those skilled in the art that further embodiments may be made without departing from the scope of the present invention.

1. A screw comprising:
a head;
a shank connected to the head;and
a plurality of threads spirally connected to the shank, said threads having a first threaded section which includes a shank point and a second threaded section which is located between the head and the first threaded section, said first threaded section having threads spiraling the opposite direction to the threads on the second threaded section, said threads on the first threaded section having an outside diameter larger than an outside diameter of the threads on the second threaded section, said threads on the second threaded section having a flank angle greater than that of the threads on the first threaded section.

2. The screw as claimed in claim 1, wherein said threads on the first threaded section have a first pitch and said threads on the second threaded section have, a second pitch, wherein said first pitch is greater than said second pitch.

3. The screw as claimed in claim 1, wherein a transition section without threads is defined between the first and the second threaded sections.

4. The screw as claimed in claim 3, wherein said transition section has a diameter greater than a diameter of said shank, said transition section having two chamfered conical edges wherein the diameter ramps longitudinally along the shank from the shank diameter to the transition section diameter gradually.

5. The screw as claimed in claim 1, wherein said head has a bottom and a top face, each being cross-sectionally circular, both faces being transverse to a shank, wherein said bottom face has a greater diameter than said top face and said bottom face has a chamfered sidewall around the circumference angling inward radially to the lesser diameter of the top face.
